(19) United States
(12) Patent Application Publication
(10) Pub. No.: US 2005/0222866 A1
(43) Pub. Date: Oct. 6, 2005

(54) Methods and systems for managing the administration of multiple medications

(76) Inventor: Grace Bender, Washington, DC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/812,936

(22) Filed: Mar. 31, 2004

(51) Int. Cl. G06F 17/60

(52) U.S. Cl. 705/2; 235/487

(57) ABSTRACT

A method for managing the administration of multiple medications may include gathering all medications to be administered, ascribing a unique identifier to each separate medication, and placing the ascribed unique identifier on a container associated with each separate medication. The method may further include compiling on a first visual medium the time each medication is to be administered and associating the unique identifier with that time and recording on a second visual medium that the administration of each medication associated with the time for administration on the first visual medium has occurred. A system for managing the administration of multiple medications may include a source of a plurality of unique identifiers configured to be associated with each of a plurality of differing medications to be administered, and first and second visual mediums in hard copy form.

### FIELD OF THE INVENTION

The present invention relates to methods and systems for managing the administration of multiple medications, including prescription medications, over-the-counter medications, vitamins, minerals, dietary supplements, and herbal products, for example. In particular, the present invention relates to methods and systems for organizing multiple medications and/or tracking the administration of multiple medications to individuals.

### RELATED ART

Systems for organizing medications are known in which individuals remove the medications from their respective packagings and place them into a series of containers marked with the various days of the week. Such a system may assist an individual in remembering to take a variety of medications each day. Such systems also may provide a time of the day associated with the marked box to help the individual remember to take particular medications at a particular time of day. These systems have drawbacks, however, in that they require the removal of the medication from its packaging, which may provide various indications about the type of medication being taken and how the medication is to be administered, for example, on an empty stomach, without alcohol, and the like. Such indications may be difficult for an individual to remember, particularly for a large number of medications or for medications that look similar. Moreover, often the containers in which the medications are to be placed comprise a single compartment, requiring all of the medications to be placed together and contact one another, which may be problematic for certain types of medications and impractical for others, such as medications in liquid form, inhalants, topical medications, and the like.

Also known are various systems to assist individuals in managing and/or tracking their health care, for example by providing a means of organizing health care records, medical history, hospitalizations, etc. Such systems also may include a form for allowing individuals to input medications they have taken or are taking. However, such systems may not facilitate the recording of which medications are to be taken, such as by providing a labeling scheme, for example, and which medications may counteract or have adverse reactions with other medications via a relatively simple system that is easily shared with health care providers.

Additionally, systems exist in which various medications to be taken by an individual are input into an electronic database and charts are provided indicating when and how each medication is to be administered. Other information may also be presented in the chart, such as the strength of the medication, for example, and a letter code associated with each medication. Again, however, such systems do not encourage users to track the actual administration of the medications. Moreover, such computer-based systems may not be suitable for assisting individuals who take multiple medications but do not have access to computers.

Overall, conventional systems and methods for managing healthcare, and particularly for managing the administration of multiple medications, often do not facilitate the sharing of information regarding the various medications an individual may be taking among the individual's various healthcare providers, including pharmacists and doctors, for example. It thus would be desirable to provide a system for managing the prescription and administration of multiple medications that also facilitates the sharing of information regarding an individual's medications among healthcare providers. In this way, a “team” approach to managing the administration of multiple medications may be accomplished by encouraging individuals on multiple medications to share recorded information regarding the various medications prescribed and/or taken by an individual with the individual's various healthcare providers. Further, it may be desirable to provide a simplified system and method by which individuals can share this information with healthcare providers so as to permit the healthcare providers, who may be the most knowledgeable about the various medications, to assist in identifying dangerous interactions between medications, the effectiveness of various medications, the appropriate dosages of medications, and/or the like in order to facilitate the management of prescribing and administering medications to the individuals.

### SUMMARY OF THE INVENTION

It should be understood that the invention could be practiced without performing one or more of the aspects described above. Other aspects will become apparent from the detailed description which follows.

As embodied and broadly described herein, an exemplary aspect of the invention may comprise a method for managing the administration of multiple medications that comprises gathering all medications to be administered, ascribing a unique identifier to each separate medication, and placing the ascribed unique identifier on a container associated with each separate medication. The method may further comprise compiling on a first visual medium the time each medication is to be administered and associating the unique identifier with that time and recording on a second visual medium that the administration of each medication associated with the time for administration on the first visual medium has occurred.

It should be understood that, as used herein, the term “medication” includes, but is not limited to, prescription medications, over-the-counter medications, vitamins, minerals, herbal products, and dietary supplements, and may be in the form of pills, liquids, topical agents, mists, inhalers, eye drops, or nose drops, for example. The term medications is intended to be used in its broadest sense and may include other types of medications not specifically listed.

According to another exemplary aspect, the invention may include a system for managing the administration of multiple medications comprising a source of a plurality of unique identifiers configured to be associated with each of a plurality of differing medications to be administered. The system may further comprise a first visual medium in hard copy form and containing indicia configured for recording the unique identifier associated with each medication and respective times of day for administering each of the plurality of medications and a second visual medium in hard copy form displaying each day the medications are to be administered and the respective times of day of administration. The second visual medium may be configured to record confirmation that the medications recorded in the first visual medium were actually administered at the appropriate time.

Yet another exemplary aspect according to the invention includes a system for managing the administration of multiple medications comprising a first means for labeling each of a plurality of medication containers containing differing medications with a unique identifier, a second means for recording a plurality of medications to be administered and respective times of day each of the plurality of medications is to be administered, and a third means for recording for each day of a month that the medications to be administered at the respective times of day recorded in the first means were administered.

### BRIEF DESCRIPTION OF THE DRAWINGS

Besides the structural and procedural arrangements set forth above, the invention could include a number of other arrangements, such as those explained hereinafter. It is to be understood that both the foregoing description and the following description are exemplary. The accompanying drawings are included to provide a further understanding of the invention and are incorporated in and constitute a part of this specification. The drawings illustrate exemplary embodiments and, together with the description, serve to explain certain principles. In the drawings,

FIG. 1 is a flow chart showing steps for managing the administration of multiple medications;

FIG. 2 is a perspective view of a medication container labeled with a symbol for identifying the medication;

FIG. 3 is a chart for recording a list of medications to be administered and respective time(s) of day each medication is to be administered;

FIG. 4 schematically illustrates various components that may be included in step 16 of FIG. 1;

FIG. 5 is a chart for recording various information corresponding to medications to be administered;

FIG. 6 is a chart for tracking the administration of multiple medications; and

FIGS. 7(a)-7(k) are schematic representations of various exemplary components that may be included a system for managing the administration of multiple medications.

### DESCRIPTION OF EXEMPLARY EMBODIMENTS

Reference will now be made in detail to exemplary embodiments of the invention, elements of which are illustrated in the accompanying drawings. Wherever possible, the same reference numbers will be used throughout the drawings to refer to the same or like parts.

As discussed above, the embodiments described herein relate to methods and systems for managing the administration of multiple medications. These systems and methods may be used by an individual taking the medications and/or by other individuals, such as, for example, relatives of the individual, health care professionals, caregivers, and the like, who may assist the individual who is taking the medications. The systems and methods described herein may be particularly suitable for assisting elderly individuals, cancer patients, cardiac patients, HIV patients, and other individuals who need to take large numbers of different medications.

More specifically, the systems and methods described herein may be useful for those individuals to not only track that their various medications were taken throughout the day, but also to easily reference indications for taking the medications, identify what each medication is used for (i.e., the purpose of each medication), identify the amount and/or dosage currently being administered, identify when the medication was started and/or stopped, identify who prescribed the medication, indicate any side effects experienced from the medication, and provide other similar notes regarding the medications, for example.

Further, the systems and methods described herein facilitate the sharing of the recorded information relating to the individual's medications and administration of those medications with healthcare providers, including an individual's doctors and pharmacists, for example. Such sharing may assist those healthcare providers in identifying potentially risky combinations of medications, amounts of medications, and/or side effects of medications. For example, individuals who are on multiple medications often may have more than one healthcare provider prescribing medications and each healthcare provider may not be aware of the medications others are prescribing. This may lead to overdosage of medications which have the same or similar effects and/or potentially dangerous interactions of medications being taken by an individual. Thus, by encouraging and facilitating the sharing of information regarding the various medications an individual is taking, the systems and methods described herein in certain exemplary embodiments may permit a more personalized approach to healthcare and the administration of multiple medications to individuals, and create a team between the individual taking the medications, the healthcare providers, and the pharmacists.

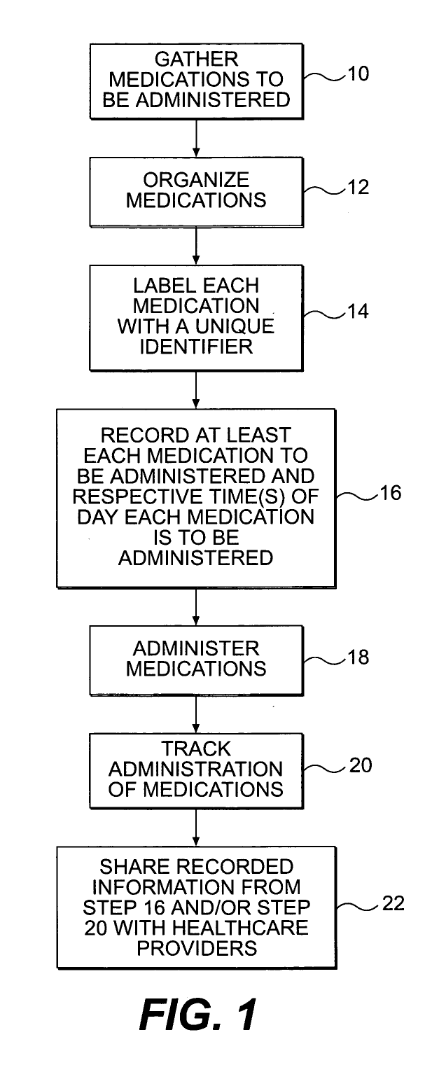

In accordance with an exemplary aspect, the present invention may include a method for managing the administration of multiple medications to an individual, for example, and may comprise at least one or more of the various exemplary steps schematically illustrated in FIG. 1.

In accordance with the exemplary embodiment of FIG. 1, the method may comprise gathering the medications to be administered to an individual, as illustrated in step 10. The medications to be gathered may include, for example, prescription medications, over-the-counter medications, vitamins, minerals, dietary supplements, and herbal products, and may be in the form of pills, liquids, topical agents, mists, inhalers, or drops, for example. The term medications, as used herein, is intended to be used in its broadest sense and may include other types of medications not specifically listed.

After gathering the medications to be administered to an individual, the method may comprise, as illustrated in the exemplary step 12 of FIG. 1, organizing the medications. The medications can be organized in virtually any way. It may be desirable to organize the medications by prescription versus nonprescription. Additionally or alternatively, it may be desirable to organize the medications by type of administration, for example, orally, topically, via inhalation. According to yet a further example, it may be desirable to organize the medications according to the time of day the medications are to be taken, for example, morning, noon, night, as needed. As another example, it may be desirable to organize the medications via indication, for example, medications to be taken on an empty stomach versus medications to be taken with food. Numerous and various methods may be used to organize the medications as illustrated by the exemplary manners of organization described above. Moreover, one or a combination of the manners of organization may be selected. Overall, any organizational structure may be selected to organize the medications with a desirable outcome being the facilitation of the correct administration of the medications.

As an example of a manner of organizing the medications so as to facilitate the administration of the medications, it may be desirable to group together medications that are taken daily and medications that are taken as needed. It further may be desirable to organize the medicines taken daily by the time of day they are taken. In this way, as will be understood further in the discussion of steps 14, 16, and 18 below, the administration of the medications may be facilitated by, for example, having all medications taken daily grouped together and all medications taken as needed grouped together. Each of the medications in the groupings can then be ascribed a unique identifier and recorded, as will be further explained in the discussion of step 16 below, in order to facilitate the correct administration of the medications.

Another exemplary step according to a method for managing the administration of multiple medications may be to ascribe a unique identifier other than the name of the medication, such as a symbol, for example, to each medication. As illustrated in step 14 of FIG. 1, the differing medications may then be labeled with the unique identifiers ascribed to each medication. By way of example only, each differing medication may be assigned a differing letter of the alphabet. Other symbols such as, for example, numbers, colors, or any other symbol that can be used for identification, and preferably for relatively easy identification, also may be used and are considered within the scope of the invention. Additionally, the labeling can occur in a variety of manners, including but not limited to, for example, placing an adhesive label (e.g., a sticker) including the symbol on the medication packaging or writing the symbol on the medication packaging. Other mechanisms for labeling also may be used and are considered within the scope of the invention.

By way of example, the unique identifiers may be assigned based on the various groupings selected in step 12. For example, if letters of the alphabet are used, the first grouping of medications, for example those taken every day, may be ascribed identifiers starting with the letter “A” and ending at the letter corresponding to the total number of medications in that group, for example “C” if there are 3 medications in that group. The second group of medications may likewise be ascribed letters, beginning with the next letter of the alphabet after the last letter used in the first grouping, for example, “D” in the scenario described above. Overall, it may be desirable to assign unique identifiers in a way that corresponds to the organization of the medications, and again, in a way that is useful to facilitate the correct administration of the medications.

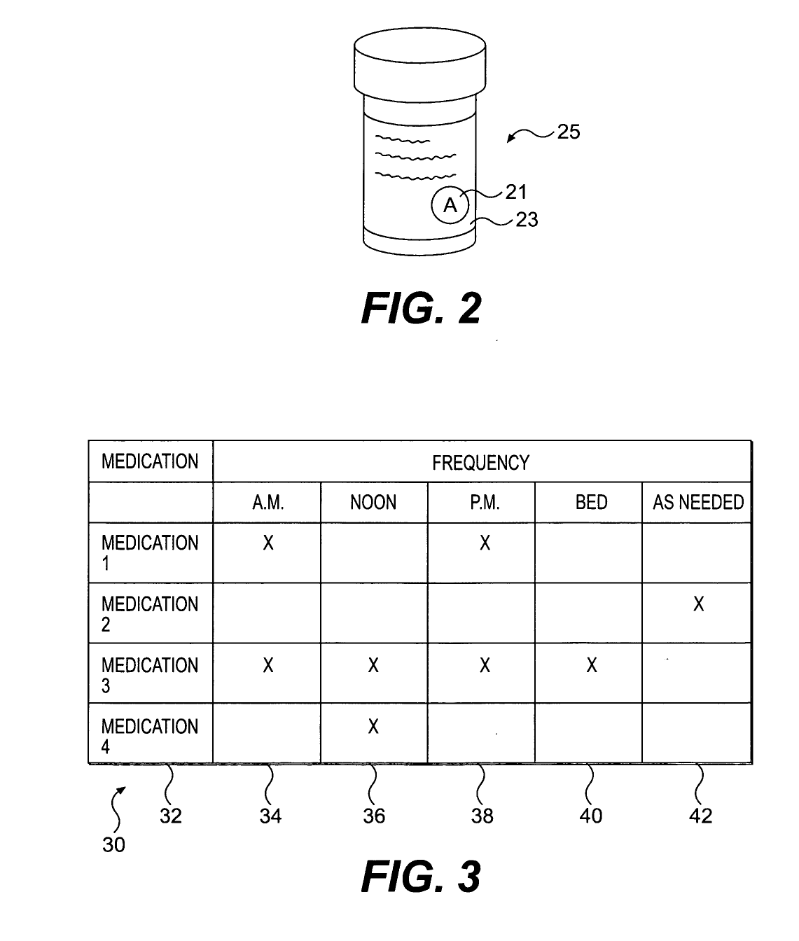

According to an exemplary aspect, at least one label containing a distinct identifier may be associated with each differing medication. For instance, at least one label may be placed at least on a portion of the medication packaging that indicates which medication is contained in the packaging. By way of example, as shown in FIG. 2, at least one adhesive label 21 may be placed on an outer side wall 23 of a conventional prescription medication container 25 that typically also includes the identification of the name and indications of the medication contained in the container. Placing the at least one adhesive label 21 on this portion of the container 25 may reduce the risk of the differing medications being mixed up due to incorrect labels being associated with a medication. For example, if labels were placed on caps or the like associated with the containers containing the medication, such caps often may fit on more than one container and could be placed inadvertently on a different container than the one it is intended to be associated with. Of course, the at least one label containing the unique identifier can be placed on any portion of the medication packaging, including a cap, for example, and such placement is considered within the scope of the invention.

A further exemplary step in the method for managing the correct administration of multiple medications may include the step, as illustrated by reference number 16 in FIG. 1, of recording at least each medication to be administered and the respective time or times of day (e.g., frequency) that each medication is to be administered. By way of example, the name of each medication may be recorded, and next to each medication an indication of when that medication is to be taken, for example, a.m., p.m., noon, as needed, every 4 hours, bedtime, etc., may be recorded. According to an exemplary aspect, as further discussed with reference to FIG. 3, for example, this information may be recorded on a visual medium in hard copy form, such as in a chart.

According to the exemplary embodiment illustrated in FIG. 3, a visual medium in the form of a hard copy chart 30 may be used to compile the information of step 16 of FIG. 1. One column 32 of the chart 30 may be used to record the various names of the medications to be administered. Next to the column 32 may be a series of columns 34, 36, 38, 40, 42, for example, for indicating the frequency with which each listed medication is to be taken. By way of example, various respective times of day can be associated with each column 34, 36, 38, 40, and 42 and marks may be placed in the column corresponding to when a particular medication is to be taken, as illustrated in the exemplary embodiment of FIG. 3.

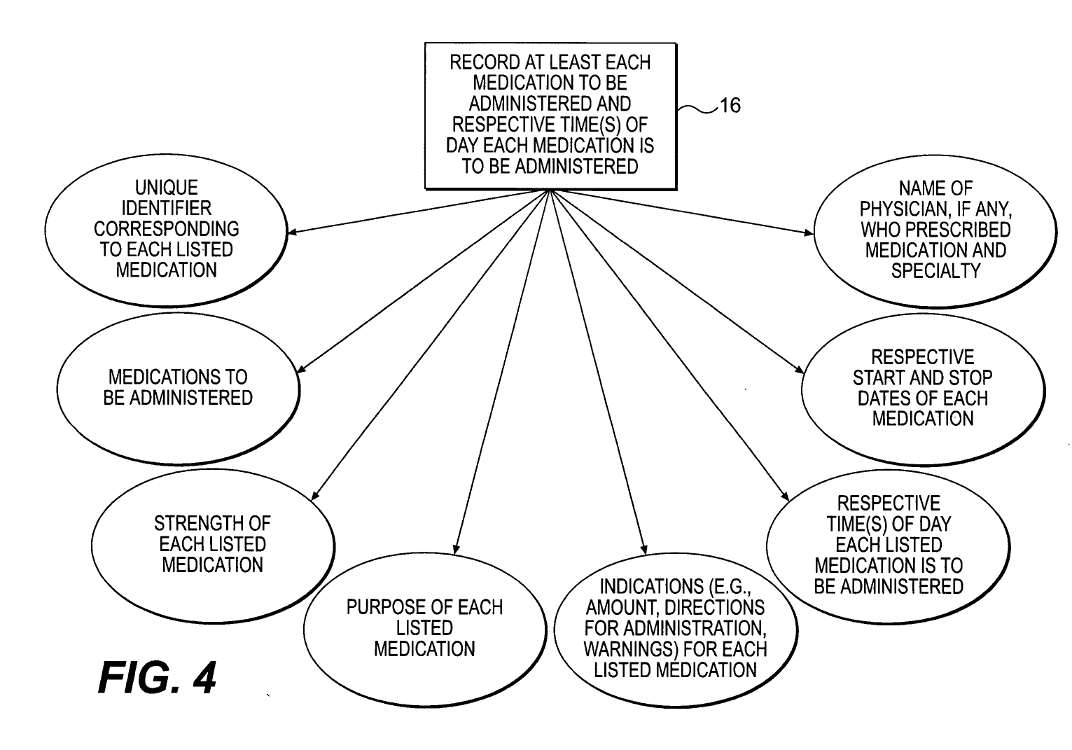

In addition to indicating each medication to be administered and the frequency with which each medication is to be administered, step 16 may also include recording a variety of other information concerning each medication. As illustrated in FIG. 4, for example, information that may be recorded includes, but is not limited to, the unique identifiers of step 14 corresponding to each medication; the purpose of each medication, such as, for example, a short hand description of what the medication is treating or is being used for (e.g., blood thinner; blood pressure, etc.); the strength of each listed medication; indications corresponding to each medication, such as, for example, the amount of each medication to be taken, directions for how each medication is to be administered, e.g., on an empty stomach, with food, without alcohol, etc. and/or warnings associated with each medication, such as, for example, side effects of the medication, other medications the particular medication may interact with, etc.; the respective start and/or stop dates of the medication; and the name of the physician, if any, who prescribed the medication, including, for example, the specialty of the physician.

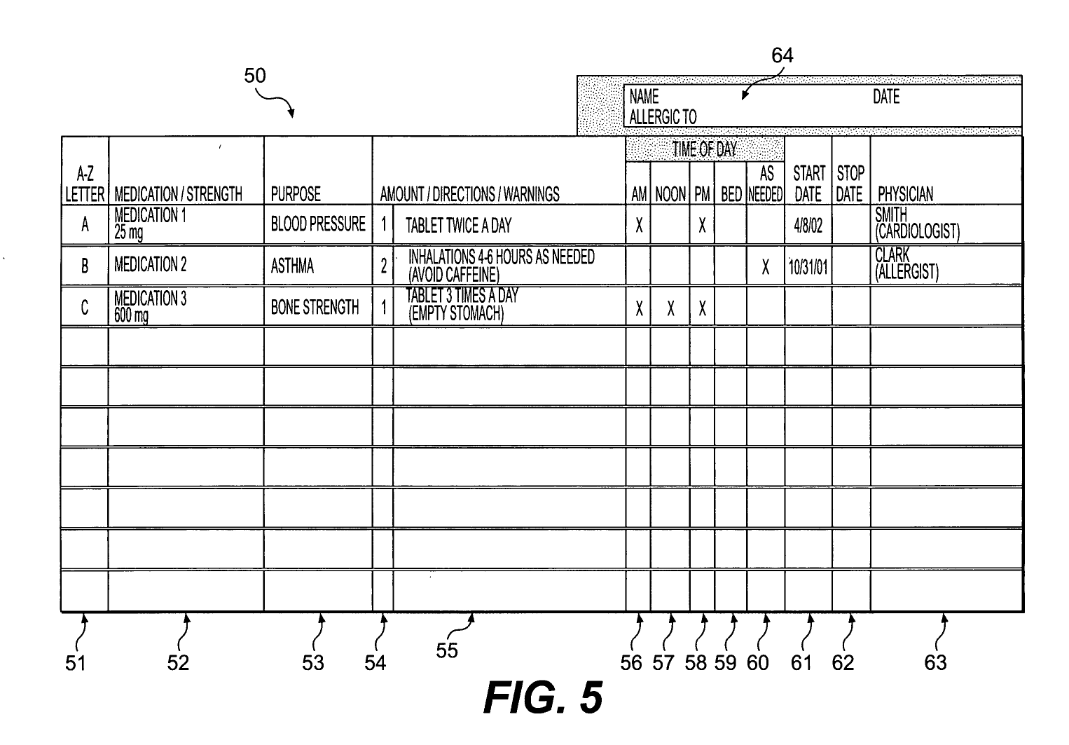

As with the exemplary embodiment of FIG. 3, the various information described above and illustrated in FIG. 4 may be recorded in a chart. An exemplary embodiment of such a chart is illustrated in FIG. 5. As shown, the chart 50 may be in hard copy form and may contain several columns 51-63, for example, corresponding to the various information to be recorded regarding each medication listed in the chart 50. Column 51 may be used to record the unique identifier, for example the letter of the alphabet, corresponding to each listed medication. Column 52 may used to record the name of each medication and the strength of each medication. Column 53 may be used to record the purpose (e.g., the condition the medication is treating) for each listed medication. Columns 54 and 55 may respectively be used to record the amount of each medication to be taken, for example, in terms of the number of doses, and the directions and/or warnings regarding the administration of the medication, such as for example, the number of tablets in a dose and how the medicine is to be administered, such as, for example, on an empty stomach, without alcohol, etc. Column 55 may also be used to list any side effects or the like corresponding to the medication. Columns 56-60 correspond to the frequency (e.g., respective time(s) a day) each listed medication is to be taken, as described in further detail with respect to FIG. 3. Columns 61 and 62 may respectively be used to record the respective start and stop dates, if any, of each medication, and column 63 may be used to record the physician, if any, who prescribed the medicine and any relevant information regarding that physician, such as, for example, the specialty of the physician.

As shown in FIG. 5, the chart 50 may also contain a space 64 for indicating the individual to whom the medications are being administered as well as any allergies that individual may have, particularly, for example, any allergies to medications.

It should be understood that the chart 50 shown in FIG. 5 is merely an exemplary embodiment of a mechanism for recording the various information described with reference to FIG. 4, and that any format for recording the information may be used. Further, various media may be used to record the information in step 16 of FIG. 1. For example, such media may include, but are not limited to, computer-readable media, hard copy media, the internet or intranet, electronic and digital recording media, audio recordable media, video recordable media, audiovisual recordable media, and any other media suitable for recording the information. Additionally, other relevant information to facilitate the management of the administration of multiple medications other than or in addition to the information shown in chart 50 and in FIG. 4 may be recorded and the information shown in the exemplary embodiments of FIGS. 4 and 5 is not intended to limit the invention.

According to another exemplary aspect, any medications recorded in step 16 that have been discontinued may be deleted, along with the information corresponding to that medication. By way of example, when using the charts of FIGS. 3 and 5, a line may be drawn through the discontinued medication and its relevant recorded information or the medication and its information may be deleted, for example, if the chart is on a computer readable media or the like.

A further exemplary step of a method for managing the administration of multiple medications includes administering the medications, as illustrated in FIG. 1. According to an exemplary aspect, administering the medications may include, at each respective time of day listed in step 18, gathering the medications to be taken at that respective time of day. The administering step may then include determining the various indications, for example, directions for administration and warnings, corresponding to each medication to be taken. As an example, such indications may be determined by referring to a single visual medium, such as chart 50, for example, discussed above. Alternatively or in addition to, such indications may be determined by reading the medication packaging associated with the medication. The administering step may further include administering each medication that has been gathered to be taken at the respective time of day. After taking each medication, the medication packaging may be placed away from the remaining gathered medications to ensure it is not taken more than once.

As illustrated in step 20 of FIG. 1, another exemplary step of the method for managing the administration of multiple medications may include tracking the administration of the medication. Numerous methods may be used to track the administration of the medication. By way of example, the tracking step 20 may be accomplished by indicating for each day in a month and each respective time of day indicated in step 16, whether all medications to be administered at that particular time were taken by the individual.

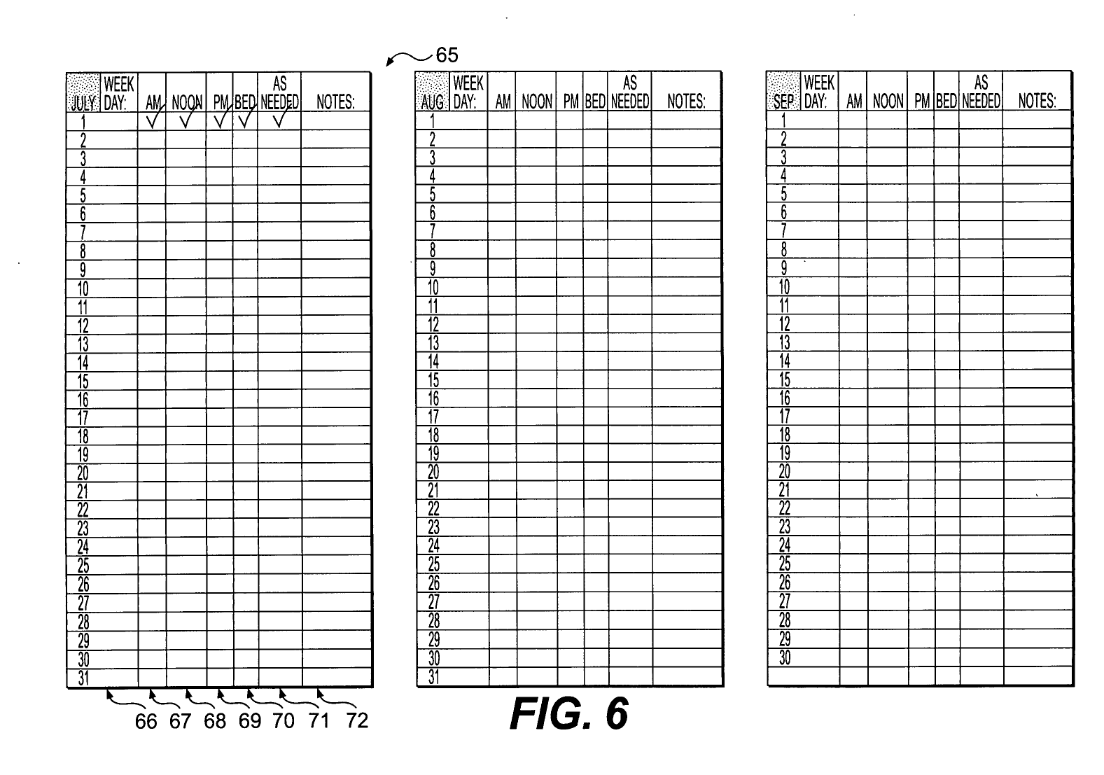

The indication of whether the medications have been administered may be recorded via numerous media. An exemplary embodiment of one such medium is shown in FIG. 6. A visual medium, such as a chart 65, may be used to indicate for each day of the month and for each respective time of day whether all of the medications to be administered at that respective time of day were administered. As shown in FIG. 6, the chart 65 may be in hard copy form and may include a column 66 containing a list of dates for each month followed by a series of columns 67-71 corresponding to the respective times of day, e.g., a.m., noon, p.m., bed, as needed, various medications are to be administered. To track the administration of the medications according to step 20 of FIG. 1, a mark, such as a checkmark or an “X,” for example, or any other appropriate notations, may be placed in the appropriate respective time box for each day to indicate that all of the medications to be administered at that respective time on that day were taken by the individual. To help ensure accurate tracking of the administration of the medications, for each day, preferably soon after the various medications have been administered at a respective time of day, a mark may be placed in the box corresponding to the respective time of day. This may be repeated for each administration of medications at each respective time of the day for each day.

As further illustrated in FIG. 6, the chart 65, according to an exemplary aspect, may include an additional column 73 for entering notes or other relevant information regarding the administration of the medicine. For example, such notes might include an indication of any effects experienced by the individual to whom the medications were administered. Such notes may be useful in determining whether the amounts of certain medications need to be varied, whether certain medications are creating side effects, whether certain medications are not mixing properly with other medications, whether certain medications are creating positive results, and/or other notes useful for indicating and managing the administration of multiple medications.

Although in the chart 65 of FIG. 6 only three months (e.g., July-September) are shown, it should be understood that all of the months of the year may be included in the chart.

Yet another exemplary step according to a method of managing the administration of multiple medications to an individual includes sharing the information recorded in step 16 and/or step 18 with the individual's healthcare providers, as illustrated by step 22 in FIG. 1. By way of example, according to certain embodiments of the systems and methods described herein, individuals are encouraged to bring the various charts described in FIGS. 3, 5, and 6, as well as other charts which will be described below, to their various doctors and pharmacist, and/or other healthcare providers, especially those healthcare providers that may be prescribing medication to the individual. In the exemplary embodiments described above wherein the charts are in hard copy form, the individual may provide the charts and/or copies of the charts to the various healthcare providers each time the individual is scheduled to see that healthcare provider. By sharing the information regarding the various medications the individual is taking, healthcare providers may play an active role in tailoring an individual's medications such that desired medical and physiological results are obtained. Further, the step of sharing the information may assist in alleviating potential risks that may occur when an individual is taking multiple medications. The charts and/or copies of the charts also may be provided to hospitals when an individual is admitted.

It should be understood that the sharing step 22 can be performed other than by bringing the physical, hard copy form of charts to healthcare providers. For instance, electronic versions of the recorded information may be provided to the healthcare providers, such as via electronic mail, CD-ROM, digital recordings, access to intranet or internet websites, and other suitable mechanisms for electronically sharing information. Additionally, the sharing step 22 may include allowing individuals to send the recorded information of steps 16 and/or 20 to a website, an electronic mail address or the like to be reviewed by healthcare professionals, either for a cost or for free. The healthcare professionals may not be associated with the particular individual (i.e., they may not be the individual's physician or pharmacist), but rather may be part of a customer service center or the like and provided to review the recorded information and provide advice on the individual's medications and administration of those medications.

Another exemplary aspect according to the invention may include a system for managing the administration of multiple medications. The system may include various media to assist in organizing multiple medications, determining which medications are to be taken at a particular time, and tracking the administration of the medications.

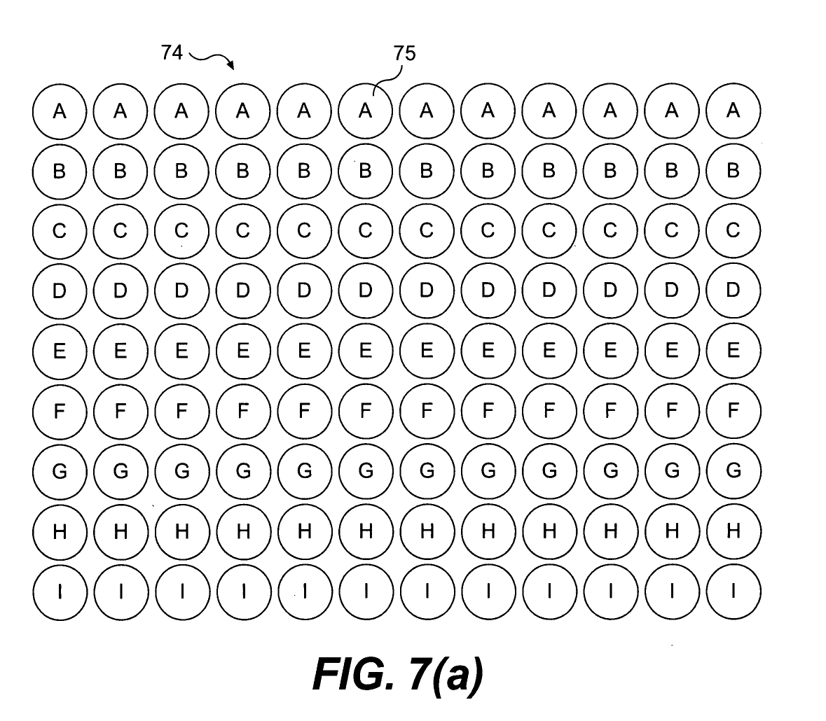

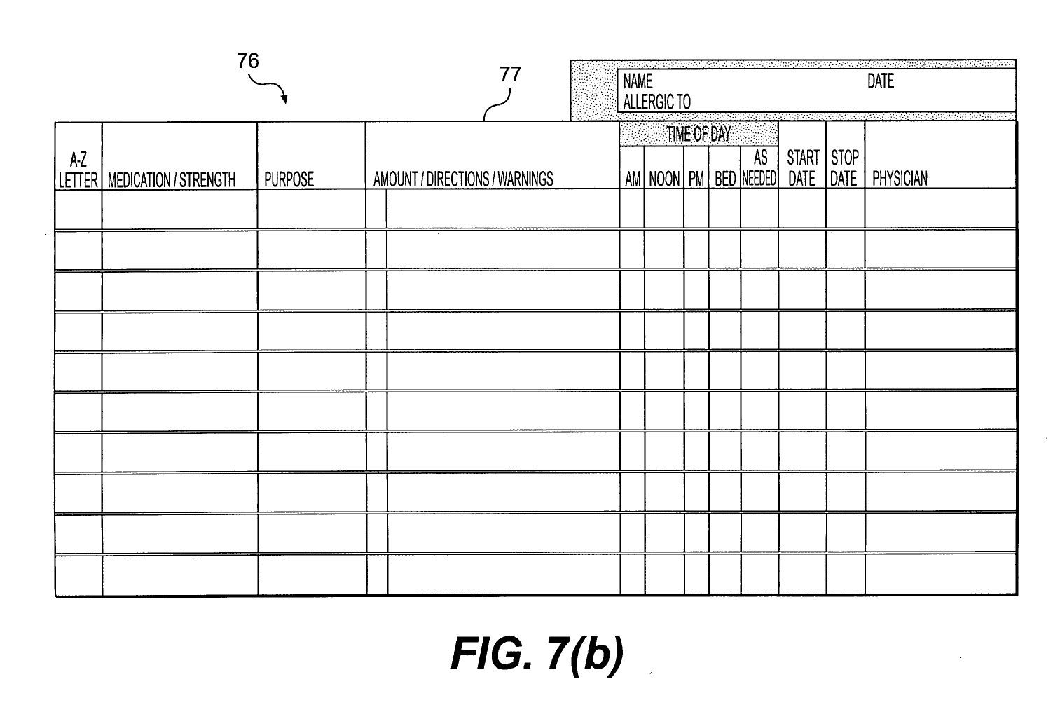

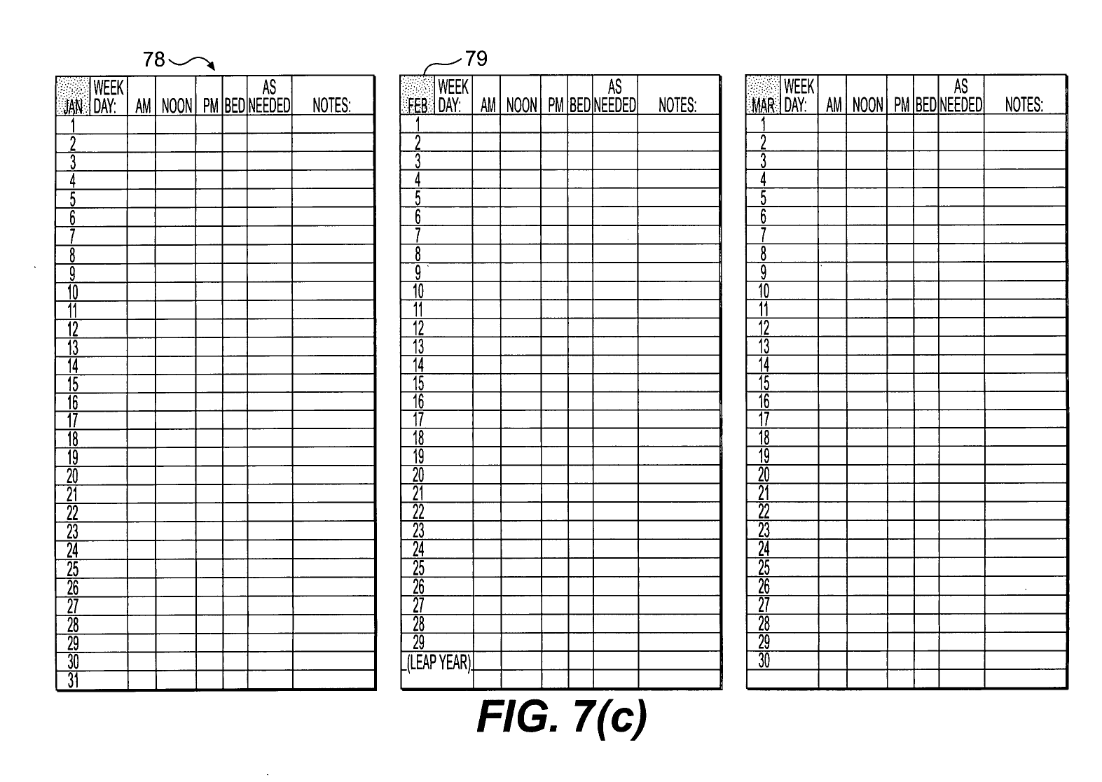

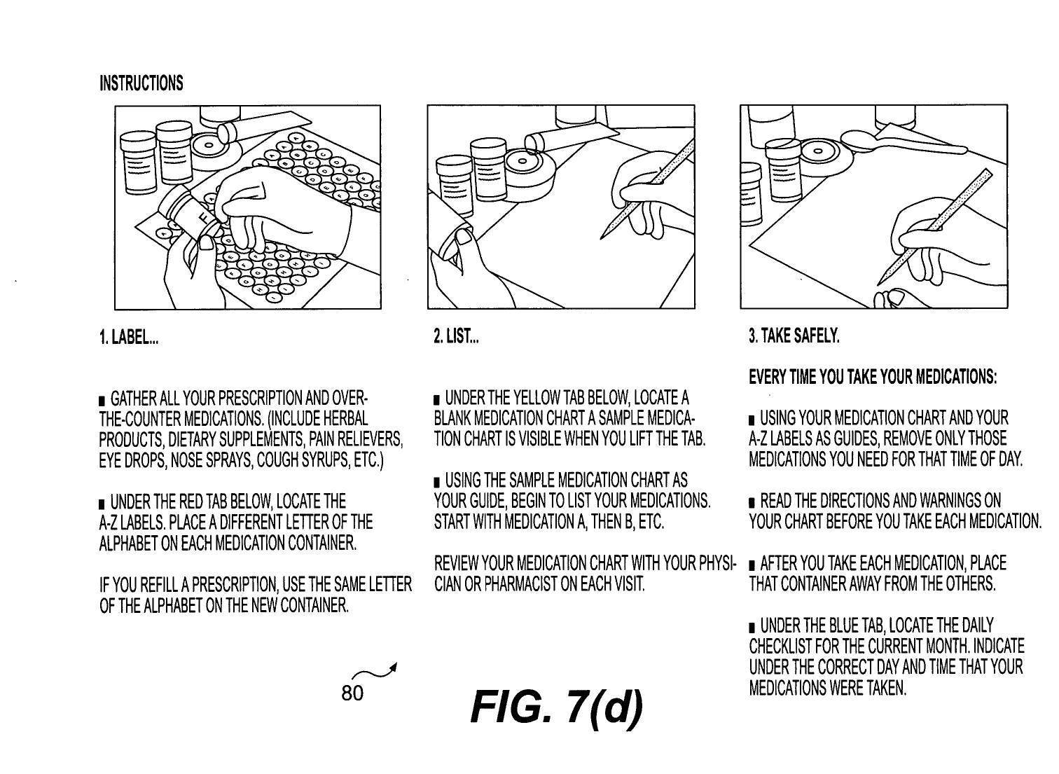

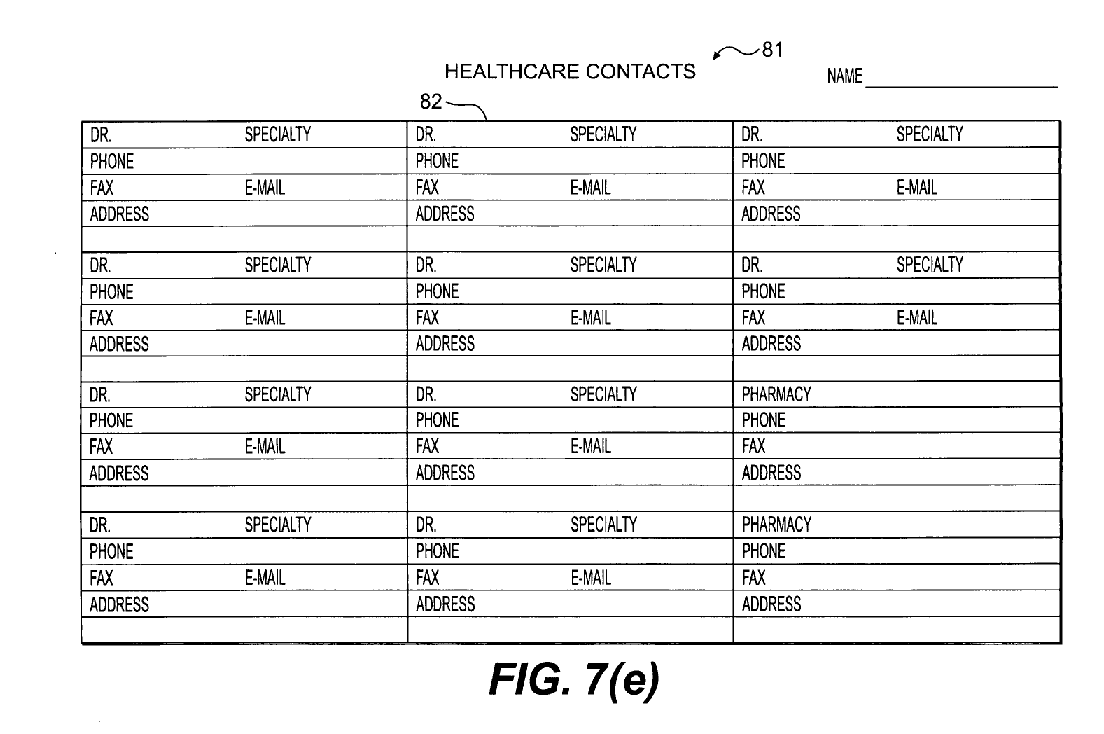

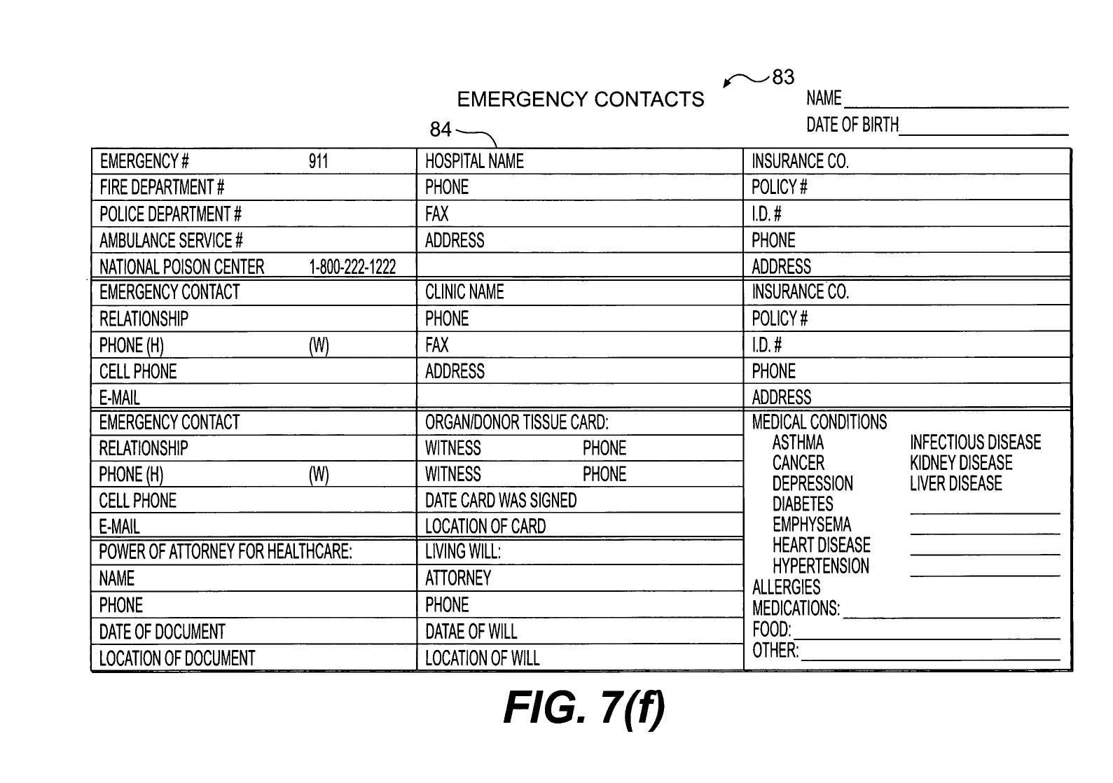

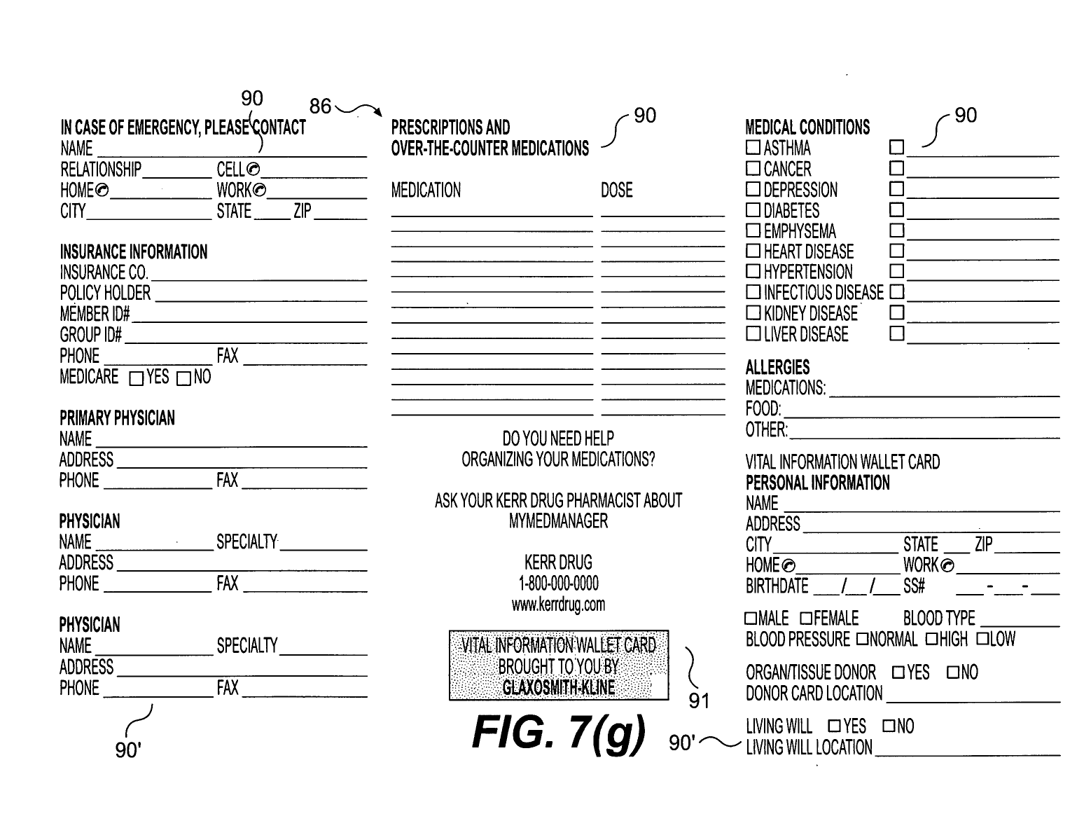

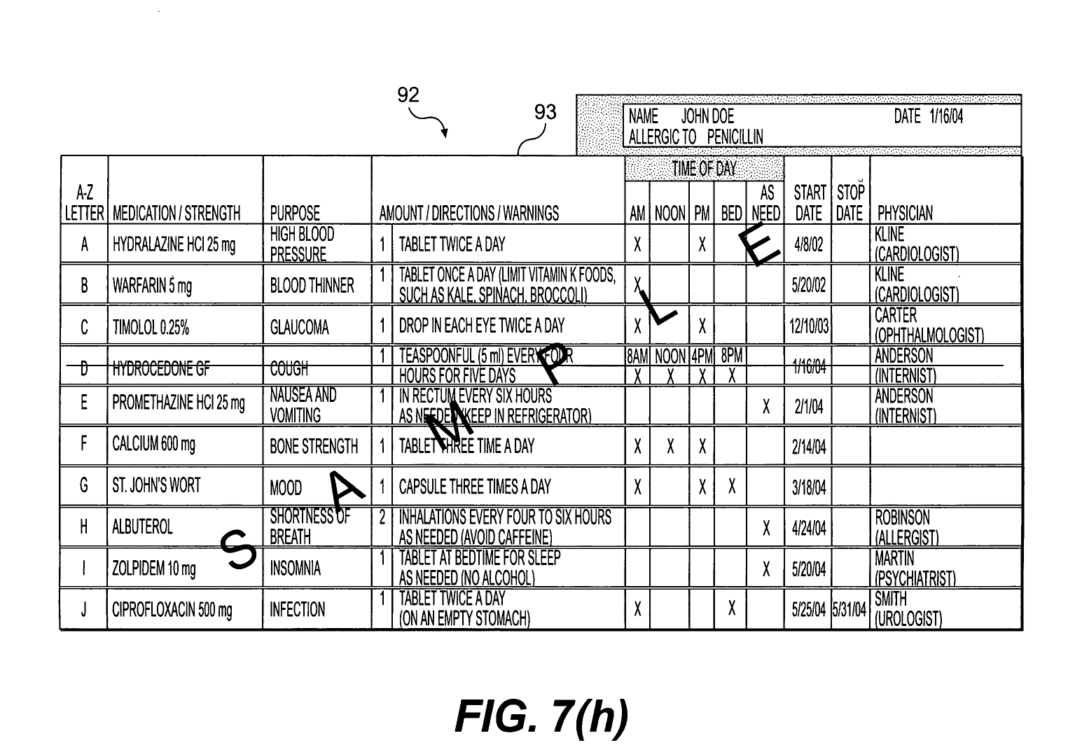

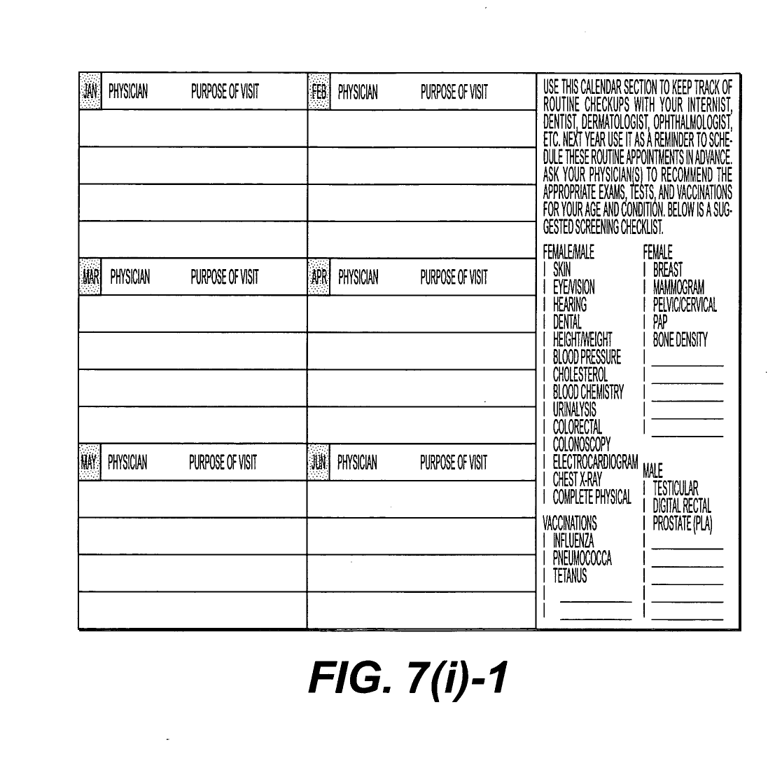

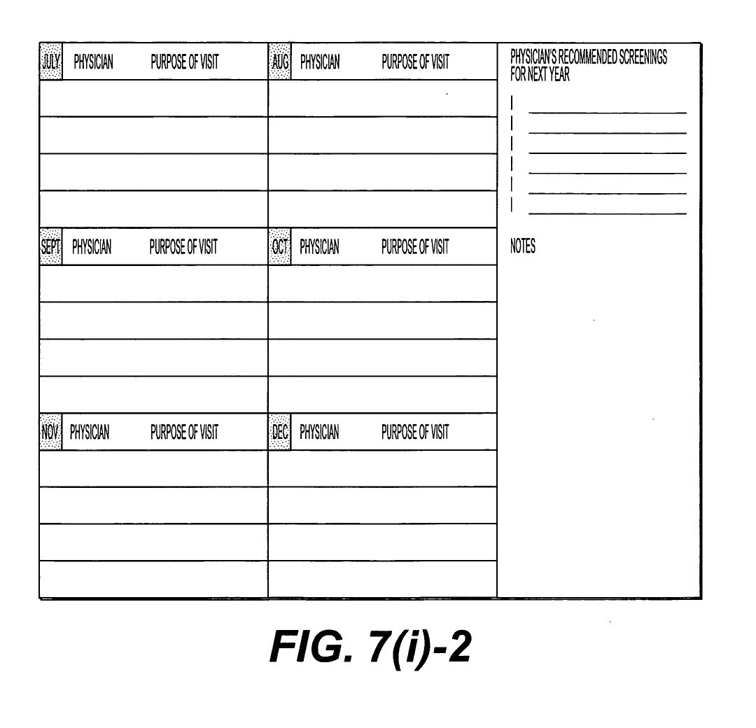

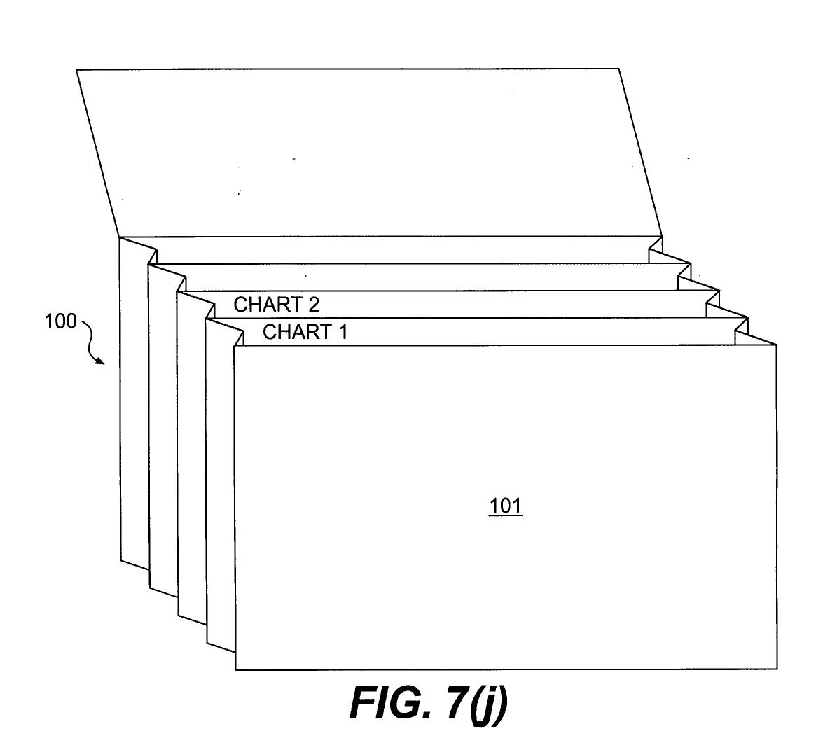

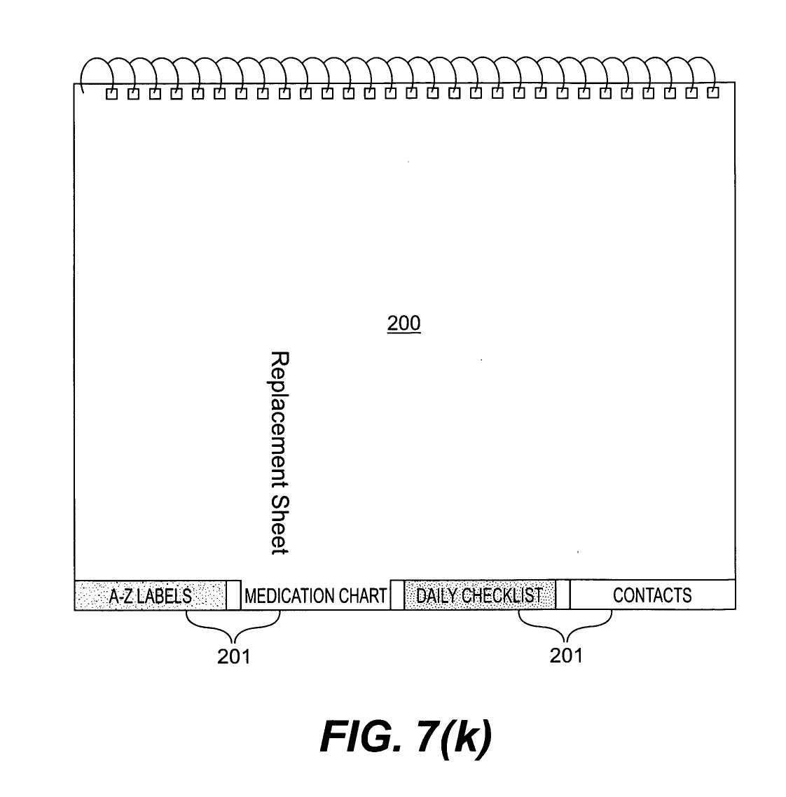

Exemplary embodiments of various components of such a system, which may be particularly suitable for use with the exemplary embodiment of the method described above, are shown in FIGS. 7(a)-7(k). The system may be in the form of a kit, for example, for managing the administration of multiple medications. A first component of the system may include a medium useful for labeling the medication packagings with symbols. According to FIG. 7(a), for example, a first exemplary component 74 of the system may be in the form of a series of adhesive labels 75 containing unique identifiers, for example in the form of letters of the alphabet. The adhesive labels 75 may be contained on a sheet and may be removable from the sheet and placed onto the packaging associated with the various medications, as described above with reference to FIGS. 1 and 2. According to the exemplary embodiment of FIG. 7(a), the component 74 may comprise twelve labels 75 corresponding to each letter of the alphabet. This may facilitate use of the identifiers for labeling the medications, as described above with reference to step 14 of FIG. 1, since medications are often prescribed for a month at a time. By providing twelve labels, the kit may be useful for labeling medications for a year at a time.

Although FIG. 7(a) shows adhesive labels 75 containing letters A through 1, it should be understood that labels containing letters A-Z may be provided. Further, though not shown in FIG. 7(a), in addition to providing adhesive labels that are printed with letters of the alphabet, the component 74 also may include a series of blank labels on which identifiers may be printed as needed. For example, unique identifiers other than those already found on the labels 75 of component 74 may be printed on the blank labels. Alternatively, additional identifiers that are the same as those already found on labels 75 of component 74 may be printed on the blank labels in the event that extra labels containing a particular identifier are needed.

Another exemplary component of the system may include a medium for recording at least the medications to be administered and respective time(s) of day each medication is to be administered. As shown in FIG. 7(b), exemplary component 76 of the system may be a visual medium in the form of a chart 77 which may be configured for recording various information corresponding to the various medications to be administered, as described with reference to FIGS. 1 and 5, for example. As an alternative to the chart 77 of FIG. 7(b), the second component 76 of the system could include a chart similar to that shown in FIG. 3. By way of example, the chart 77 may be in hard copy form.

Yet another exemplary component of the system may include a medium for tracking the administration of the medications. FIG. 7(c) illustrates an exemplary component 78 in the form of a chart 79 configured for recording an indication of whether on a particular day, at a particular time, all medications to be administered at that particular time were administered. By way of example, the chart 79 may be a chart similar to that discussed above with reference to FIG. 6 and may be in hard copy form.

A further exemplary component of the system may include a medium for providing instructions to users of the system for managing the administration of multiple medications. FIG. 7(d) illustrates an exemplary component 80 in the form of text providing instructions for using the system comprising the components of FIGS. 7(a)-7(c) and 7(h). It should be understood that the instructions could be modified from those shown in FIG. 7(d) depending on the nature of the various components of the system and other similar factors. Those having skill in the art would understand how such instructions could be modified in accordance with the particularities of the various medium and components used in the system. Moreover, it should be understood that various media for providing the instructions are within the scope of the invention. Such media may include, for example, hard copies of the written instructions, audio recordings, video recordings, audiovisual recordings, electronic or digital storage media such as CD-ROM, disk, or DVD, for example, internet or intranet addresses which link to web or other graphics pages containing instructions, and any other media capable of storing and providing instructions to users.

A further exemplary component of a system for managing the administration of multiple medications may include a medium for recording information concerning the various health care providers and/or references for the individual to whom the medications are administered. FIG. 7(e) illustrates an exemplary component 81 in the form of chart 82 configured for recording information, such as, for example, name, specialty, phone number, fax number, address, e-mail address, and/or other relevant information corresponding to various healthcare providers. Such healthcare providers may include, but are not limited to, doctors, pharmacists, nurses, psychologists, and other health care professionals.

Yet another exemplary component for a system for managing the administration of multiple medications may include a medium for recording emergency contact information. FIG. 7(f) illustrates an exemplary component 83 in the form of chart 84 which may be used for recording such information including, but not limited to, information regarding an individual's fire department, police department, ambulance service, hospital, insurance company, clinic, emergency contacts, power of attorney for healthcare and other information about the power of attorney, living will attorney and other information about the living will, and organ/tissue donor card, for example. The information that may be recorded regarding these items includes, for example, names, phone numbers, addresses, fax numbers, policy numbers, i.d. numbers, dates of execution, location of relevant documents, and any other relevant information. Additionally, the chart 84, as shown in the exemplary embodiment of FIG. 7(f) may include a space for recording information containing to medical conditions, allergies, and or other medical information of an individual.

In an exemplary embodiment, the charts 82 and 84 shown in FIGS. 7(e) and 7(f) may be provided on a single hard copy sheet, with chart 82 provided on one side of the sheet and chart 84 provided on the opposite side of the sheet.

Yet another exemplary component of a system for managing the administration of multiple medications is a vital information “pocket-sized” card. An exemplary embodiment of such a card 86 is illustrated in FIG. 7(g). As shown in FIG. 7(g), the card 86 may have a plurality of panels 90, 90′ for recording vital information. Panels 90 represent a first side of a sheet and panels 90′ and 91 represent the opposite side of the sheet. The vital information that may be recorded on panels 90, 90′ may include, but is not limited to, personal information such as name, address, phone numbers, birthdate, social security number, gender, blood type, blood pressure, indication of whether the individual is an organ/tissue donor, location of such an organ/tissue donor card, whether the individual has a living will and the location of the living will, emergency contact information, insurance information, information regarding the individual's physicians, information regarding the various medications an individual is taking, medical conditions and/or allergies of the individual. In addition to the various panels for recording information pertaining an individual's healthcare, the card 86 may also include a panel 91 on which advertising for a sponsor may be located. For example, the name, contact information, and/or other information of a pharmacy selling the system of FIG. 7 may be provided on the panel, and/or the name, contact, and/or other information of a drug manufacturer may be provided on the panel. Of course any type of advertising may be provided on the panel and is considered within the scope of the invention.

The various panels may be folded, for example in a tri-fold relationship, so as to reduce the size of the card 86 to a size that is more easily carried in a wallet, a purse, a pocket, or the like. It should be understood that the arrangement and types of information provided on the card 86 is exemplary only and other arrangements and types of information are contemplated as being within the scope of the invention. Further, the “pocket-sized” card for recording and carrying the information may be in hard copy form, as illustrated in FIG. 7(g), or may be provided via a variety of other media, such as, for example, an electronic-readable format, such as a card with a magnetic strip for example, which is able to have the various information recorded thereon and accessible electronically, a CD-ROM, a personal data, an other mechanisms for storing and retrieving information.

FIG. 7(h) shows another exemplary component of a system for managing the administration of multiple medications. Component 92 may be chart 93 similar to chart 77 described above except the chart 93 may be provided as a sample chart already containing exemplary information filled in. Such a sample chart may be helpful in assisting individuals using the system to fill in the chart 77 with the individual's medications.

Another exemplary component of a system for managing the administration of multiple medications is illustrated in FIG. 7(i). The component 94 may be in the form of a chart 95, for example in hard copy form, configured to record scheduled appointments with healthcare providers, the purpose of the appointment, and/or other similar information. Such a component may be particularly suitable for recording routine checkups and the like. The exemplary chart 95 contains the months of the year and spaces for recording dates of scheduled appointments in each month. Next to each space for recording the dates of scheduled appointments, spaces may be provided for recording the name of the healthcare provider corresponding to the scheduled appointment. Further, a space may be provided for indicating the purpose of the visit. Another exemplary aspect of the chart 95 shown in FIG. 7(i) includes a list of various routine examinations and/or screening tests which it may be desirable to schedule.

A further exemplary component of a system for managing the administration of multiple medications may include a medium for retaining (e.g., storing) one or more of the various components described with reference to FIGS. 7(a)-7(i). FIG. 7(j) is a perspective view of an exemplary component 100 in the form of a folder 101 configured for retaining the various components, for example, the sheets of labels, charts, instruction sheets, and vital information card described above. Of course, it should be understood that a variety of media could be used to store the various components of the system for managing the administration of multiple medications described above. For example, such media may include electronic or digital storage media, such as CD-ROM, disk, DVD, and the like, capable of storing various components in computer-readable form, internet, intranet, or web-based media capable of storing components for access over an internet or intranet, audio, video, or audio-visual recording and storage mechanisms, and other similar media capable of storing and permitting retrieval of the components for use with the system described above.

Another exemplary component for retaining (e.g., storing) one or more of the various components described with reference to FIGS. 7(a)-7(i) is a spiral bound notebook. An exemplary embodiment of such a spiral bound notebook 200 is shown in FIG. 7(k). The spiral bound notebook 200 may contain the various charts discussed in FIGS. 7(a)-7(i). In an exemplary aspect, the various charts may be provided with perforations so as to facilitate removal of the charts from the spiral bound notebook if desired. Moreover, to facilitate organization, the spiral bound notebook may include one or more labeled dividers (e.g., tabbed dividers) 201 separating each of the various chart types contained in the notebook. As shown in the embodiment of FIG. 7(k), for example, a divider 201 separating each of the various charts of FIGS. 7(b), 7(c), 7(e), and 7(f) and the labels of FIG. 7(a) may be provided. A sample chart, for example as shown in FIG. 7(h) may also be included under the divider labeled “medication chart.” It should be understood that the various dividers 201 illustrated in FIG. 7(k) are exemplary only and other labeled dividers may be used to indicate the contents of the spiral notebook. Further, the selection of dividers may depend, for example, on which components of FIGS. 7(a)-(i) above are included in the system and contained in the spiral notebook. Additionally, such dividers may be used to separate the contents of the folder of FIG. 7(j).

Aside from a spiral bound notebook, it also is contemplated that other forms of bound notebooks, such as an adhesive bound notebook, for example, may be used to hold the various exemplary components of the system described in FIGS. 7(a)-7(i).

As mentioned above, the exemplary components of the system of FIG. 7 may be supplied to the user through a variety of media. As an example, the various charts, instructions, and labels may be supplied to the user via hard copy, and/or be supplied via software, a computer-readable media, over the internet or intranet, and printed by the user. Alternatively, the user could access the various charts and instructions online and/or via a computer or other electronic or digital media and input and store information in the charts via a computer or other electronic or digital media. Those having skill in the art would understand various mechanisms for permitting users to access, input, and record the various items of information corresponding to the exemplary components of the exemplary system of FIG. 7.

Additionally, the various charts, such as chart 77 in FIG. 7(b), for example, may be filled in with medications by the individual's doctors, pharmacists, and/or other healthcare providers. As an example, the individual's pharmacist may fill in the chart with the various prescription medications that the individual receives from the pharmacist, as that information would be readily accessible to the pharmacist. When filling prescriptions, the pharmacist may provide the chart to the individual listing all prescription medications to be taken by the individual. Blank spaces may be provided for the individual to fill in nonprescription medications that the individual is taking and/or other medications of which the pharmacist may be unaware.

As discussed above with respect to FIG. 1, a method of managing the administration of multiple medications may include providing the recorded information regarding the medications and the administration thereof, and other healthcare information of an individual, to healthcare providers, such as physicians, hospitals, nurses, and pharmacists, for example. By way of example, one or more of the various components of FIG. 7 with the information recorded therein may be provided to the individual's physicians and pharmacists, and/or to a hospital upon admission of the individual. It should be understood that the various information could be provided to healthcare providers in numerous ways. For example, hard copies of the various charts could be provided, electronic copies of the various charts could be provided, the information may be saved on a website to which healthcare providers and the individual taking the medications may have access, and/or a variety of other mechanisms may be used that are capable of sharing such information.

By sharing this information with healthcare providers, potential problems with medications being administered may be identified and the administration of certain medications may be altered accordingly. For instance, often an individual on multiple medications is being prescribed medications from a variety of doctors, in addition to taking nonprescription medications which may be selected by the individual. Thus, the various doctors may not realize all the various medications an individual is taking, and also may have no relatively easy way to obtain this information. This may lead to problems such as, for example, the prescribing of counteracting or interacting medications or to the inadvertent overdosing of medications. The systems and methods described herein may alleviate such potential problems by providing an efficient way to share the information regarding all of the differing medications an individual is taking. In this way, a “team” approach between the various healthcare providers, including the pharmacist, and the individual to the administration of medications may be accomplished.

It will be apparent to those skilled in the art that various modifications and variations can be made to the methods and systems described above for managing the administration of multiple medications, without departing from the scope of the invention. As an example, the systems and methods may include one or more of the various steps or components described above with reference to FIGS. 1 and 7(a)-7(k). For example, in an exemplary embodiment, the system may include the components shown in FIGS. 7(a)-7(h) and 7(k). Further, the system of FIG. 7 may comprise more than one of any of the components shown in FIGS. 7(a)-7(i). By way of example, a plurality of one or more of the various charts and sheets of labels described above with reference to FIGS. 7(a)-7(i) may be provided. For instance, a pad, similar to a pad of paper, of each type of chart may be provided and as a chart is needed by the individual, the chart on top may be torn away from the rest of the pad. Moreover, information other than the types of information described above may be recorded using the various exemplary embodiments described herein.

Moreover, in addition to using the systems and methods discussed herein to manage the administering of medications for individuals, such systems and methods also could be used to manage the administration of medications to animals, for example, pets.

It will be apparent to those skilled in the art that various modifications and variations can be made to the systems and methodology described above. Thus, it should be understood that the invention is not limited to the examples discussed in the specification. Rather, the present invention is intended to cover modifications and variations.

1. A method for managing the administration of multiple medications, the method comprising:
gathering all medications to be administered;
ascribing a unique identifier to each separate medication;
placing the ascribed unique identifier on a container associated with each separate medication;
compiling on a first visual medium the time each medication is to be administered and associating the unique identifier with that time; and
recording on a second visual medium that the administration of each medication associated with the time for administration on the first visual medium has occurred.

2. The method of claim 1, wherein the first and second visual mediums are charts.

3. The method of claim 2, wherein the first and second visual mediums are hard copies of charts.

4. The method of claim 1, further comprising recording on the first visual medium the name of each medication to be taken and associating the name with the unique identifier and the time for administration.

5. The method of claim 1, further comprising, for each identifier, recording on the first visual medium the purpose of the medication corresponding to each identifier.

6. The method of claim 1, further comprising, for each identifier, recording on the first visual medium the respective start and/or stop dates of the medication corresponding to each identifier.

7. The method of claim 1, further comprising, for each identifier, recording on the first visual medium the dosage amount of the medication corresponding to each identifier that is to be taken at each administration.

8. The method of claim 1, further comprising, for each identifier, recording on the first visual medium the strength of the medication corresponding to each identifier.

9. The method of claim 1, further comprising, for each identifier, recording on the first visual medium directions and/or warnings associated with the medication corresponding to each identifier.

10. The method of claim 1, further comprising, for each identifier, recording on the first visual medium a prescribing physician of the medication corresponding to each identifier.

11. The method of claim 10, further comprising, for each identifier, recording on the first visual medium the specialty of the prescribing physician.

12. The method of claim 11, wherein the placing of the unique identifier includes placing the unique identifier on a portion of the container indicating the name of the medication.

13. The method of claim 1, wherein the placing of the unique identifier includes placing the unique identifier on a side wall of the container.

14. The method of claim 1, wherein the placing of the unique identifier includes placing an adhesive label on each container.

15. The method of claim 1, wherein the placing of the unique identifier includes printing the identifier on each container.

16. The method of claim 1, further comprising sharing the information contained in the first visual medium with healthcare providers of the individual.

17. The method of claim 16, further comprising sharing the information contained in the second visual medium with healthcare providers of the individual.

18. The method of claim 16, wherein the sharing of the information includes sharing the information with the individual's pharmacists, physicians, and/or a hospital to which the individual is admitted.

19. The method of claim 16, wherein the sharing of the information includes providing copies of the first and second visual mediums.

20. A system for managing the administration of multiple medications, the system comprising:
a source of a plurality of unique identifiers configured to be associated with each of a plurality of differing medications to be administered;
a first visual medium in hard copy form and containing indicia configured for recording the unique identifier associated with each medication and respective times of day for administering each of the plurality of medications; and
a second visual medium in hard copy form displaying each day the medications are to be administered and the respective times of day of administration, the second visual medium being configured to record confirmation that the medications recorded in the first visual medium were actually administered at the appropriate time.

21. The system of claim 20, further comprising a third medium configured to place the unique identifiers on each of a plurality of containers containing each separate medication.

22. The system of claim 21, wherein the third medium comprises adhesive labels containing the unique identifiers for identifying each of the medications to be administered.

23. The system of claim 22, wherein the identifiers comprise letters of the alphabet.

24. The system of claim 23, wherein the third medium comprises, for each letter of the alphabet, twelve adhesive labels containing the respective letter of the alphabet.

25. The system of claim 23, wherein the third medium further comprises a plurality of blank adhesive labels.

26. The system of claim 21, wherein the third medium comprises printed identifiers on each medication.

27. The system of claim 20, further comprising a folder.

28. The system of claim 22, further comprising a folder configured to hold the labels, the first visual medium and the second visual medium.

29. The system of claim 20, further comprising a notebook configured to hold the labels, the first visual medium, and the second visual medium.

30. The system of claim 29, wherein the notebook is a spiral bound notebook.

31. The system of claim 30, wherein the notebook is an adhesive bound notebook.

32. The system of claim 29, wherein the labels, the first visual medium, and the second visual medium are removable from the notebook.

33. The system of claim 32, wherein the labels, the first visual medium, and the second visual medium are perforated so as to permit removal from the notebook.

34. The system of claim 29, wherein the notebook comprises dividers for separating the labels, the first visual medium, and the second visual medium.

35. The system of claim 20, wherein the first visual medium contains indicia configured for recording, for each identifier, a purpose of the medication corresponding to each identifier.

36. The system of claim 20, wherein the first visual medium contains indicia configured for recording, for each identifier, the respective start and/or stop dates of the medication corresponding to each identifier.

37. The system of claim 20, wherein the first visual medium contains indicia configured for recording, for each identifier, the dosage amount of the medication corresponding to each identifier that is to be taken at each administration.

38. The system of claim 20, wherein the first visual medium contains indicia configured for recording, for each identifier, the strength of the medication corresponding to each identifier.

39. The system of claim 20, wherein the first visual medium contains indicia configured for recording, for each identifier, directions and/or warnings associated with the medication corresponding to each identifier.

40. The system of claim 20, wherein the first visual medium contains indicia configured for recording, for each identifier, a prescribing physician of the medication corresponding to each identifier.

41. The system of claim 40, wherein the first visual medium contains indicia configured for recording, for each identifier, the specialty of the prescribing physician.

42. The system of claim 20, further comprising use instructions for directing users how to use the system.

43. The system of claim 42, wherein the use instructions are in hard copy form.

44. The system of claim 20, further comprising a sample visual medium of the first visual medium, wherein the sample visual medium contains sample information useful for demonstrating how to record information in the first visual medium.

45. The system of claim 20, further comprising a third visual medium containing indicia configured for recording healthcare and/or emergency contact information.

46. The system of claim 45, wherein the third visual medium includes at least one chart.

47. The system of claim 45, wherein the third visual medium is in hard copy form.

48. The system of claim 20, further comprising a third visual medium containing indicia configured for recording scheduled medical appointments.

49. The system of claim 48, wherein the third visual medium includes a chart.

50. The system of claim 20, further comprising a card containing indicia configured to record vital information regarding an individual's healthcare.

51. The system of claim 50, wherein the card is approximately pocket-sized.

52. A system for managing the administration of multiple medications, the system comprising:
a first means for labeling each of a plurality of medication containers containing differing medications with a unique identifier;
a second means for recording a plurality of medications to be administered and respective times of day each of the plurality of medications is to be administered; and
a third means for recording for each day of a month that the medications to be administered at the respective times of day recorded in the first means were administered.

53. The system of claim 52, further comprising a fourth means for storing the first means, the second means, and the third means.

54. The system of claim 52, further comprising a means for providing use instructions for using the system.
